(19) United States
(12) Patent Application Publication
(10) Pub. No.: US 2016/0210689 A1
(43) Pub. Date: Jul. 21, 2016

(54) CONTENT ITEM CONFIGURATION OPTIMIZATION

(71) Applicant: Google Inc., Mountain View, CA (US)

(72) Inventor: Patrick Hummel, Cupertino, CA (US)

(73) Assignee: Google Inc., Mountain View, CA (US)

(21) Appl. No.: 14/599,015

(22) Filed: Jan. 16, 2015

(51) Int. Cl. G06Q 30/08; G06F 17/30; G06Q 20/40

(52) U.S. Cl. CPC G06Q 30/08; G06Q 20/40; G06F 17/30477

(57) ABSTRACT

Systems and methods of optimizing a configuration of content items for display with an online document are provided. A system can identify from a content database a configuration for the online document and a configuration attribute for the configuration, which can include one or more content item slots. The system can determine a selection factor for the configuration based on the configuration attribute. The system can obtain a bid value for a content item and a click-through attribute for the content item slot of the content item configuration. The system can select the configuration based on the selection factor, the bid values for the content item, and the click-through attributes for the content item slot. The system can authorize the content item slot of the configuration to include a content item. The system can provide the online document with the content item for display by a computing device.

### BACKGROUND

In a computer networked environment such as the Internet, entities such as people or companies provide information for public display on web pages or other online documents. The documents can include information provided by the entities via a computing device for display on the Internet. Content can also be provided by third parties for display on the documents together with the information provided by the entities. Thus, a person viewing a document can access the information that is the subject of the document, as well as third party content that may or may not be related to the subject matter of the document.

### SUMMARY

At least one aspect is directed to a method of optimizing configuration of content items for display with an online document. The method can include identifying from at least one content database a content item configuration for the online document and a configuration attribute for the content item configuration, which may comprise a content item slot. The method can include determining by a selection factor determination module executing on the data processing system a selection factor for the content item configuration based on the configuration attribute. The method can include obtaining by the data processing system a bid value for the content item and a click-through attribute for the content item slot. The method can include selecting by a selection module executing on the data processing system the content item configuration based on the selection factor, the bid value for the content item, and the click-through attribute for the content item slot. The method can authorize by the selection module the content item slot of the content item configuration to include the content item. The method can provide by the data processing system the online document with the content item for display by a computing device.

At least one aspect is directed to a system for optimizing configuration of content items for display with an online document. The system can comprise a data processing system comprising at least one processor. The data processing system can identify from at least one content database a content item configuration for the online document and a configuration attribute for the content item configuration, the content item configuration comprising a content item slot. The selection factor determination module executing on the data processing system can determine a selection factor for the content item configuration based on the configuration attribute. The data processing system can obtain a bid value for a content item and a click-through attribute for the content item slot. The selection module executing on the data processing system can select the content item configuration based on the selection factor, the bid value for the content item, and the click-through attribute for the content item slot. The selection module can authorize the content item slot of the content item configuration to include the content item. The data processing system can provide the online document with the content item for display by a computing device.

At least one aspect is directed to a computer readable storage medium storing instructions that when executed by one or more data processors, cause the one or more data processors to perform operations. The operations can identify from at least one content database a content item configuration for the online document and a configuration attribute for the content item configuration, the content item configuration comprising a content item slot. The operations can determine a selection factor for the content item configuration based on the configuration attribute. The data processing system can obtain a bid value for a content item and a click-through attribute for the content item slot. The operations can select the content item configuration based on the selection factor, the bid value for the content item, and the click-through attribute for the content item slot. The operations can authorize the content item slot of the content item configuration to include the content item. The operations can provide the online document with the content item for display by a computing device.

At least one aspect is directed to a method of optimizing the configuration of content items for display with an online document. The method can include identifying from at least one content database a content item configuration for the online document and a configuration attribute for the content item configuration, which may comprise one or more content item slots. The method can include determining by a selection factor determination module executing on the data processing system a selection factor for the content item configuration based on the configuration attribute. The method can include obtaining by the data processing system a bid value for each of one or more content items and a click-through attribute for each of the one or more content item slots. The method can include selecting by a selection module executing on the data processing system the content item configuration based on the selection factor, the bid values for each of the content items, and the click-through attributes for each of the content item slots. The method can authorize by the selection module each content item slot of the content item configuration to include a content item. The method can provide by the data processing system the online document with the one or more content items for display by a computing device.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram depicting one example environment to optimize the configuration of content items on an online document, according to an illustrative implementation;

FIG. 2 is a display depicting one example of an online document with one configuration of content items, according to an illustrative implementation;

FIG. 3 is a display depicting another example of an online document with another configuration of content items, according to an illustrative implementation;

FIG. 4 is a flow diagram depicting an example method of optimizing the configuration of content items on an online document, according to an illustrative implementation;

FIG. 5 is a flow diagram depicting an example method of optimizing the configuration of content items on an online document, according to an illustrative implementation; and

FIG. 6 is a block diagram illustrating a general architecture for a computer system that may be employed to implement elements of the systems and methods described and illustrated herein, according to an illustrative implementation.

Like reference numbers and designations in the various drawings indicate like elements.

### DETAILED DESCRIPTION

The systems and methods described herein can determine information about the performance of various content item configurations, for example by using a selection or scaling factor to scale up (or down) the probability of selecting a certain online document configuration for display with content items. For example, absent a selection factor certain online document configurations may have a low probability of being selected relative to other configurations. These low-probability configurations may be referred to herein as degenerate configurations. Due to a presumed or determined inferior configuration, there may be less or a statistically insignificant amount of information about the effectiveness of online document displays with degenerate configurations.

The selection factor (e.g., a weight) can increase the likelihood that the data processing system will select the degenerate configuration for display with content items. The data processing system can obtain data from these displays (e.g., impressions, clicks, bid values, or conversions) and can use this data to determine whether or not the presumed degenerate configuration is in fact an inferior configuration relative to other ad slot configurations of the online document. Thus, the computer system can select and evaluate online document displays with various ad configurations to determine the quality or value (e.g., in terms of conversions, clicks, impressions, or monetary value) of the various configurations.

The systems and methods described herein can optimize the configuration of content items such as advertisements for display in advertisement space (e.g., content item slots) on an online document (e.g., webpage) using an explore-and-exploit technique. An online document can display with various content item slot configurations, including displays with a number of content item slots that is less than the maximum number of content item slots available on the online document. A data processing system (e.g., a computer system) can use a position normalizer to determine the relative click-through rates in one position compared to another. To optimize the configuration of advertisements (or other content items), the data processing system can: determine selection factors based on configuration attributes; select a configuration of advertisements based on the selection factors determined, the bids and predicted click-through rates of the advertisers, and the click-through attributes of the content item slots; and set prices for advertisements based on the selection factors, the bids and predicted click-through rates of the advertisers, the click-through attributes of the content item slots, and economic welfare.

The data processing system can determine selection factors for each configuration of advertisements based on the attributes of the configuration. The configuration attributes can include the number of times that the configuration with a particular number of advertisements has been displayed or seen. For example, there may be one configuration of an online document that has one advertisement for display and another configuration with two advertisements for display. The configuration attribute for the online document configuration with one advertisement may have been displayed 200 times in a time period (e.g., per hour) and the online document configuration with two advertisements may have been displayed 300 times in the same time period. Furthermore, online document configurations can vary based on the location of content item slots. For example, there may be various online document configurations with the same number of advertisements displayed, but with the content item slots in different positions on the webpage or other online document, e.g., banner slots, above-the fold, or along the margins of the online document.

The selection (e.g., scaling) factors can represent to what extent each configuration may be explored for the purposes of determining information about the position normalizers for the respective configuration. The selection factors may be based on an arbitrary decreasing or non-increasing function of the number of times an advertisement was displayed or the number of times the configuration was displayed, for example. Furthermore, the data processing system can determine selection factors for a specific webpage or a website associated with a particular content publisher. The selection factors can be determined at any frequency of time.

The data processing system can select the configuration of advertisements to display with an online document. The configuration can be selected based on the configuration that maximizes some function of the bids of the displayed content items, the click-through attributes of the content item slots of the configuration, and the selection factor for the respective configuration. The bid by the advertiser may differ for various positions in the configuration. The click-through rates can also differ for each position in the configuration.

The data processing system can set a price for the advertisement (or other content item) based on a comparison between the configuration with the advertisement displayed versus alternate configurations. The price set can be the difference between the scaled economic welfare that would have arisen if the advertiser's advertisement was not displayed versus the scaled economic welfare that arose from the advertisement being displayed. The difference can be further scaled by the selection factor for the configuration selected and the predicted click probability for the position of the advertisement within the configuration. The price set may be below the amount the advertiser budgeted in the bid. In addition, the price set can be above or below the price the advertiser would have been charged had the selection factor not been used or determined.

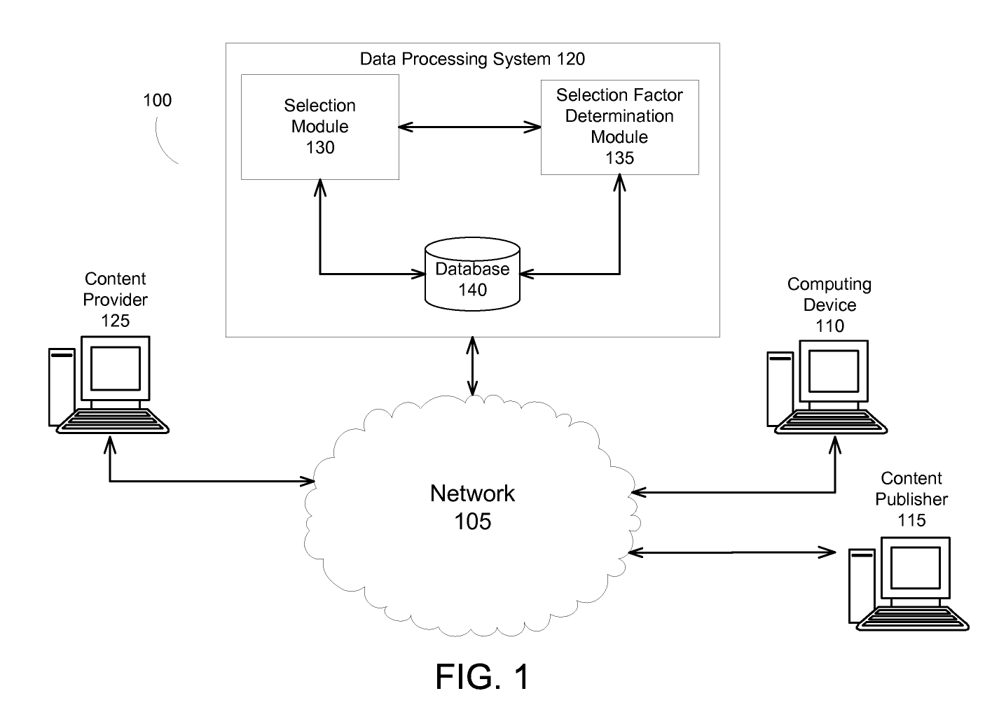

FIG. 1 illustrates an example system 100 for optimization of a configuration of content items for display with an online document infrastructure. The content selection infrastructure can include a data processing system 120 communicating with one or more of a content provider 125, content publisher 115, or computing device 110 via a network 105. The network 105 can include computer networks such as the Internet, local, wide, metro, or other area networks, intranets, satellite networks, and other communication networks such as voice or data mobile telephone networks. The network 105 can be used to access information resources such as web pages, web sites, domain names, or uniform resource locators that can be displayed on at least one computing device 110, such as a laptop, desktop, tablet, personal digital assistant, smart phone, or portable computers. For example, via the network 105 a user of the computing device 110 can access web pages provided by at least one web site operator or content publisher 115. In this example, a web browser of the computing device 110 can access a web server of the web site operator or content publisher 115 to retrieve a web page for display on a monitor of the computing device 110. The web site operator or content publisher 115 generally includes an entity that operates the web page. In one implementation, the web site operator or content publisher 115 includes at least one web page server that communicates with the network 105 to make the web page available to the computing device 110.

The network 105 may be any type or form of network and may include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. The network 105 may include a wireless link, such as an infrared channel or satellite band. The topology of the network 105 may include a bus, star, or ring network topology. The network may include mobile telephone networks using any protocol or protocols used to communicate among mobile devices, including advanced mobile phone protocol (“AMPS”), time division multiple access (“TDMA”), code-division multiple access (“CDMA”), global system for mobile communication (“GSM”), general packet radio services (“GPRS”) or universal mobile telecommunications system (“UMTS”). Different types of data may be transmitted via different protocols, or the same types of data may be transmitted via different protocols.

The system 100 can include at least one data processing system 120. The data processing system 120 can include at least one logic device such as a computing device having a processor to communicate via the network 105, for example with the computing device 110, the web site operator or content publisher computing device 115, and at least one content provider computing device 125. The data processing system 120 can include at least one server. For example, the data processing system 120 can include a plurality of servers located in at least one data center. The data processing system 120 can include multiple, logically-grouped servers and facilitate distributed computing techniques. The logical group of servers may be referred to as a server farm or a machine farm. The servers can also be geographically dispersed. A machine farm may be administered as a single entity, or the machine farm can include a plurality of machine farms. The servers within each machine farm can be heterogeneous—one or more of the servers or machines can operate according to one or more type of operating system platform.

Servers in the machine farm can be stored in high-density rack systems, along with associated storage systems, and located in an enterprise data center. For example, consolidating the servers in this way may improve system manageability, data security, the physical security of the system, and system performance by locating servers and high performance storage systems on localized high performance networks. Centralizing the servers and storage systems and coupling them with advanced system management tools allows more efficient use of server resources.

The data processing system 120 can include a selection module 130, a selection factor determination module 135, and at least one database 140. The selection module 130 or selection factor determination module 135 can include at least one processing unit or other logic device such as a programmable logic array engine, or module configured to communicate with the database 140. The selection module 130 and selection factor determination module 135 can be separate components, a single component, or a part of the data processing system 120. The system 100 and its components, such as a data processing system, may include hardware elements, such as one or more processors, logic devices, or circuits.

The data processing system 120 can obtain anonymous computer network activity information associated with a plurality of computing devices 110. A user of a computing device 110 can affirmatively authorize the data processing system 120 to obtain network activity information corresponding to the user's computing device 110. For example, the data processing system 120 can prompt the user of the computing device 110 for consent to obtain one or more types of network activity information, such as geographic location information. The identity of the user of the computing device 110 can remain anonymous and the computing device 110 may be associated with a unique identifier (e.g., a unique identifier for the user or the computing device provided by the data processing system or a user of the computing device). The data processing system can associate each observation with a corresponding unique identifier.

For situations in which the systems discussed here collect personal information about users, or may make use of personal information, the users may be provided with an opportunity to control whether programs or features that may collect personal information (e.g., information about a user's social network, social actions or activities, a user's preferences, or a user's current location), or to control whether or how to receive content from the content server that may be more relevant to the user. In addition, certain data may be treated in one or more ways before it is stored or used, so that certain information about the user is removed when generating parameters (e.g., demographic parameters). For example, a user's identity may be treated so that no identifying information can be determined for the user, or a user's geographic location may be generalized where location information is obtained (such as to a city, ZIP code, or state level), so that a particular location of a user cannot be determined. Thus, the user may have control over how information is collected about the user and used by a content server.

The data processing system 120 can identify a content item configuration for an online document. The data processing system 120 or one or more components of system 100 can identify content item configurations for the online document from processing the online document. For example, when first loading the online document from the content publisher 115 or content provider 125, the data processing system 120 can process the HTML code underlying the online document to identify the content item configurations.

The data processing system 120 can also obtain content item configurations from the database 140 or another database. For example, when the data processing system 120 loads the online document, the data processing system 120 can obtain the content item configurations for the online document from a database provided by or associated with the content provider 125 or the content publisher 115. The other databases can transmit the content item configurations for the online document via the network 105. The data processing system 120 can also obtain the content item configurations from data provided by the computing device 110. For example, when the computing device 110 loads the online document associated with or provided by the content provider 125, the computing device can transmit a request to the data processing system 120 along with data concerning the content item configurations of the online document.

The data processing system 120 can determine or identify the content item configuration by making an estimation from data associated with the online document. For example, when loading the online document associated with or provided by the content provider 125 via the network 105, the data processing system 120 can determine content item configurations by recognizing or identifying white space or negative space with a certain area (e.g., 728 pixels by 90 pixels) on the online document, when first processing the online document.

An online document, such as one associated with or operated by the content publisher 115 can be, for example, a webpage or at least part of an application displayed or executed by a computing device 110. An online document can have a plurality of content item configurations. For example, the number of content items slots can differ among the plurality of content item configurations. The number of content item slots can also be either the same or different among the plurality of content item configurations. The size of content item slots can be the same or different among the plurality of content item configurations The position of the content item slots on the online document may be the same or different among the plurality of content item configurations. In addition, the content item configuration can include signifiers indicating whether the content item slot can move, be animated, or contain audiovisual content.

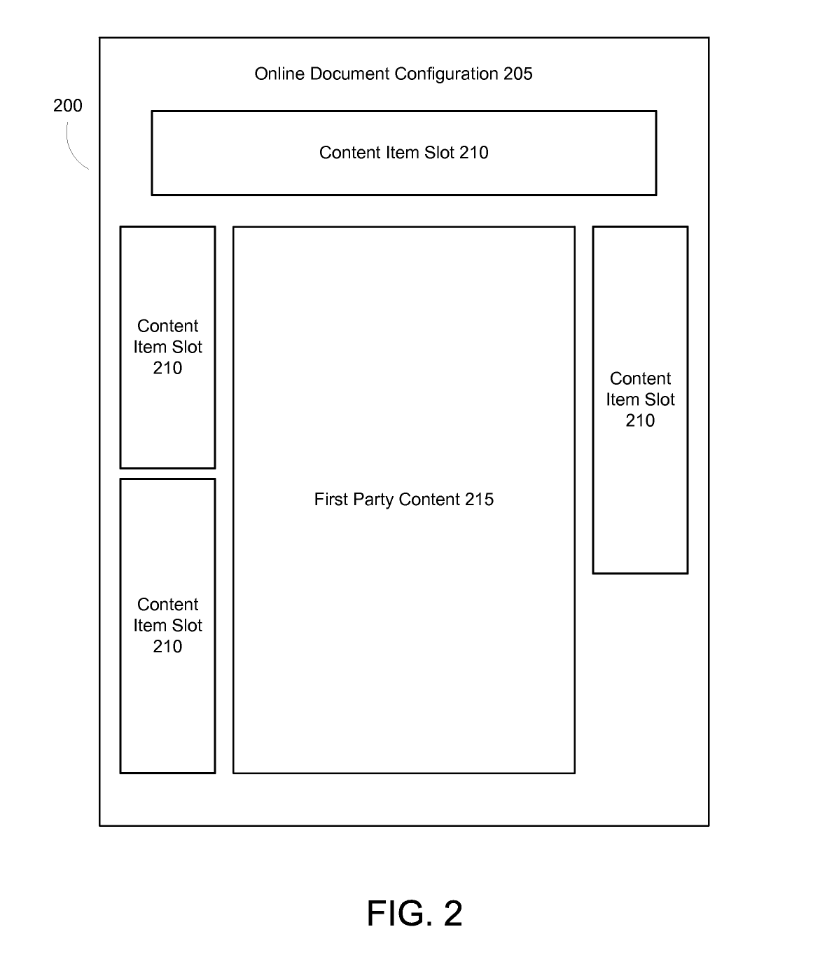

FIG. 2 depicts one of many examples of online document configurations 205 for an online document 200 with four content item slots 210 and first party content 215. Content item slots 210 can be space in the online document 200 designated to present or provide a link to content associated with or provided by a content publisher 115 or a content provider 120, such as a banner ad, frame ad, floating or overlay ad, expanding ad, or interstitial ad. Content item slots 210 can be of different sizes and locations. In the online document configuration 205, there is one content item slot 210 along the top banner position of the online document 200. There are two content item slots 210 on the left margin of the online document 200. In the example of FIG. 2, there is also one content item slot 210 on the right margin of the online document 200. All four content item slots 210 can be different sizes. For example, the top left content item slot 210 is of smaller size than the bottom left content item slot 210. The bottom left content item slot 210 is in turn smaller than the content item slot 210 in the right margin. The bottom left content item slot 210 is in turn smaller than the content item slot 210 in the top banner position. The first party content 215 is located generally centered within the online document 200.

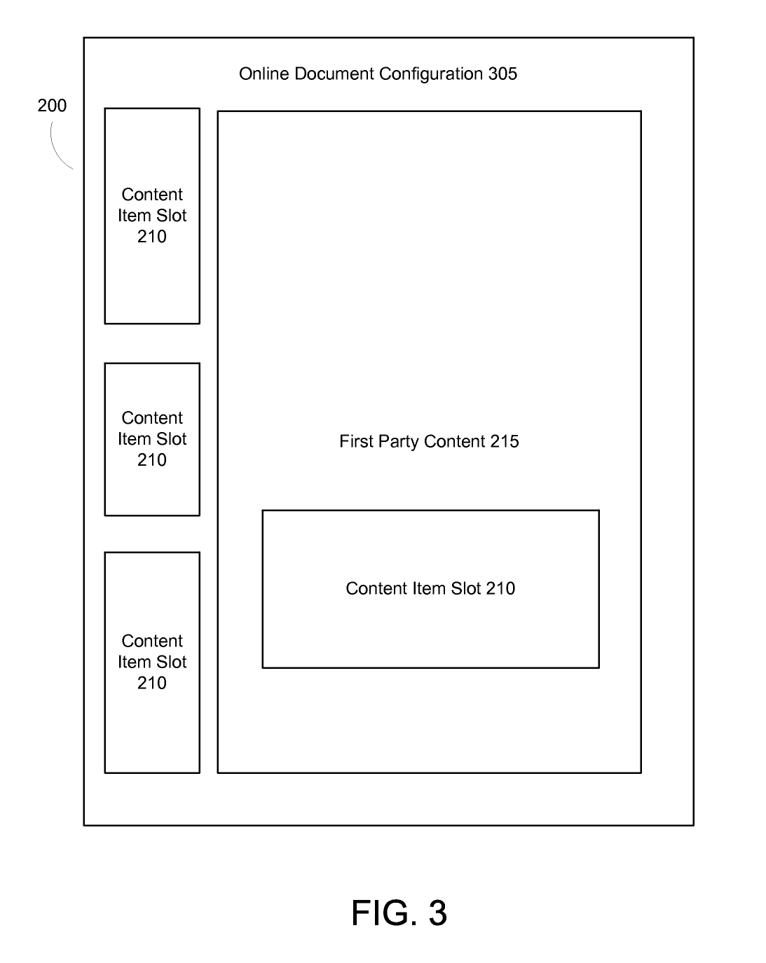

FIG. 3 depicts another one of many examples of online document configurations 305 for the same online document 200 with four content item slots 210 with first party content 215. In FIG. 3, on the online document configuration 305, there are three content item slots 210 along the left margin of online document 200 and one content item slot 210 that is embedded, surrounded by, or hovering over the first party content 215. The content item slots 210 are of differing size. The three content item slots 210 along the left margin of the online document 200 are of different size, with the top content item slot 210 and the bottom content item slot 210 of larger size than the middle content item slot 210. The content item slot 210 embedded or surrounded by or hovering over the first party content 215 is of different size from the other three content item slots 210. The first party content 215 and one of the content item slots 210 located within are located generally right within the online document 210.

FIG. 2 and FIG. 3 depict two of many examples of online document configurations and are for illustrative purposes, as there may be many other possible online document configurations besides online document configurations 205 and 305. For example, there can be a number of content item slots 210 other than four, such as one or one hundred. In addition, content item slots 210 can appear in any location of the online document 200, giving the online document 200 configurations different from the online document configurations 205 and 305. For example, the online document 200 can include four content item slots 210 in a first content item configuration and three content item slots 210 in a second content item configuration. In another example, the online document 200 can include three content item slots 210 located along the left of the first party content 215 in a first content item configuration and three content item slots 210 with one located in the banner position, one surrounded by first party content 215, and one located along the right side of the online document, in a second content item configuration. In another example, the online document 200 can include two content item slots 210, both along the left side of the first party content 215 and of the same size, in a first content item configuration and two content item slots 210, both along the left side of the first party content 215 with one square and the other rectangular, in a second content item configuration.

The selection factor determination module 135 can determine a selection factor that represents the degree to which the probability of selecting an online document configuration (e.g., online document configurations 205 and 305) for display with content items should be scaled up (or down) based on the configuration attributes for the online document configurations. A configuration attribute can include the number of times the content item configuration was displayed on the online document, a group of online documents, website, or an application. For example, suppose that for online document 200 online document configuration 205 has been displayed 50 times per hour and online document configuration 305 has been displayed 400 times per hour. Online document configuration 205 can be referred to as a degenerate online document configuration, because the online document configuration 205 is displayed at a lower rate than online document configuration 305. The selection factor determination module 135 can determine that the selection factors for online document configurations 205 and 305 are 0.7 and 0.5 respectively. In this example, the selection factors indicate that online document configuration 205 will now have a higher probability of display for online document 200 than it would if the selection factors were equal, because the selection factor for online document configuration 205 is greater than the selection factor for online document configuration 305. Using the selection factor as well as other parameters, the selection module 130 can select the online document configuration (e.g., online document configuration 205 or 305). The selection factors of 0.7 and 0.5 for online document configurations 205 and 305 are for illustrative purposes, as selection factors can include any range of values, such as integers, Booleans, and non-numerical values.

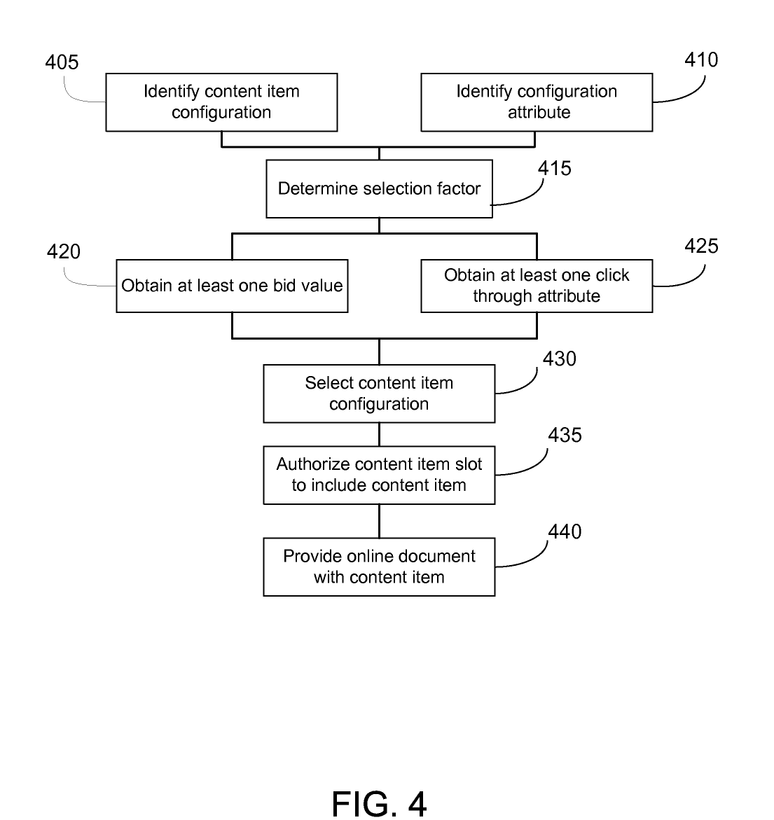

FIG. 4 is an illustration of a method or workflow 400 for optimizing the configuration of content items for display with an online document, such as the online document 200. The method 400 can be performed or executed by one or more components of system 100 shown in FIG. 1, including, e.g., the data processing system 120. The method 400 can be performed or executed at various time intervals, ranging from once every few seconds or minutes to once every predetermined number of days. The method 400 can be performed or executed upon the fulfillment of a conditional, e.g., a condition determined or received by the data processing system 120 such as reaching a predetermined number of visitors to the online document or website. The method 400 can also be performed or executed every time a user visits the online document 200 or website.

The data processing system 120 can identify a content item configuration (e.g., online document configurations 205 and 305) for an online document from at least one content database (ACT 405). The content database can be the database 140 of the data processing system 120 or a database provided by the computing device 110, content publisher 115, or content provider 125, or any other associated database. The online document 200 can have various content item configurations, such as online document configurations 205 and 305. The content item configurations can vary by a number of content item slots, size of content item slots, or position of content item slots, such as online document configurations 205 and 305 depicted in FIGS. 2 and 3 respectively. The content item configuration can include signifiers indicating whether the content item slot may move, be animated, or contain audiovisual content.

The data processing system 120 can identify a configuration attribute for the content item configurations (e.g., online document configurations 205 and 305) from at least one content database (e.g., database 140) (ACT 410). The configuration attribute can include the number of times the content item configuration was displayed on the online document, a group of online documents, website, or application. The configuration attribute can also include the number of times the content item configuration was viewed (i.e., impressions) on the online document, a group of online documents, website, or application. For example, when loading the online document 200, the data processing system 100 can identify the configuration attribute for the content item configurations by retrieving the attribute or attributes stored in a database, such as database 140 or any one or more components in system 100.

The configuration attribute can also include the number of times the content item configuration was clicked, or the number of times the content item configuration was estimated to have been viewed, or the number of times the content item configuration was estimated to have been displayed on the online document, a group of online documents, website, or application. For example, when loading the online document 200, the data processing system 120 can estimate a number of views of the online document 200 based on the traffic statistics of other online documents 200, provided by or associated with the content publisher 115. Estimates of the configuration attribute, e.g., made by the data processing system 120, can be based on machine learning algorithms that consider the configuration attributes of similar content item configurations, for example. The data processing system 120 can obtain information about the number of times the content item configuration was clicked or viewed, for example, from the database 140 or from another database via the network 105.

A selection factor determination module 135 executing on the data processing system 120 or one or more components of system 100 can determine a selection factor (ACT 415). The selection factor can represent the degree to which the selection factor determination module 135 will scale up (or down) the probability of displaying the content item configurations with degenerate configuration attribute, such as a lower number of times the content item configuration was displayed, viewed, or clicked relative to another content item configuration. For example, prior to or during loading of the online document 200, the selection factor determination module 135 can retrieve the online document configurations 205 and 305 and configuration attributes from a database (e.g., database 140) via the network 105 and proceed to determine selection factors for the content item configuration based on the configuration attributes.

The selection factor can be or include a scaling factor or a numerical weight, such as 0.7 and 0.5 as described in a previous example. The selection factor can include or indicate a numerical weight based on a non-increasing or decreasing function of at least one of the configuration attributes. For example, the selection factor determination module 135 can determine the selection factor based on a non-increasing function such as one of the form:

$$f ( {n}_{k} ) = 1 + \frac{c}{{n}_{k}^{α}}$$

where c is some positive constant, nₖ is the number of times content item configuration k was displayed, viewed, or clicked, and a is an arbitrary positive number. In this example, the non-increasing function has the characteristic that as nₖ reaches infinity the function ƒ(nₖ) reaches one. In addition, the numerical weight can be arbitrarily chosen using a search algorithm. For example, the selection factor determination module 135 can determine the selection factor based on at least one of the configuration attributes by using a search algorithm such as hill climbing to scale up the probability of display of a randomly chosen content item configuration.

The selection factor determination module 135 can also use optimization algorithms, e.g., gradient ascent/descent, greedy algorithms, dynamic programming, or convex optimization, to determine the selection factor. For example, when processing the online document 200, the selection factor determination module 135 can determine the selection factor based on history of the results of previous determination of the selection factor to optimize the configuration attribute of the content item configuration. In this example, suppose the previous scaling factors for online document configurations 205 and 305 were 0.7 and 0.5 respectively and the number of views per hour for each configuration changed by 100 and −25 respectively. The selection factor determination module can identify that the previous selection factors were effective and determine the selection factors for the next determination accordingly, such as the selection factors of 0.75 and 0.45 for online document configuration 205 and 305 respectively.

The selection factor can be a non-numerical indicator representing the degree to which the selection factor determination module 135 will give preference to content item configurations with a certain configuration attribute. For example, suppose that a first content item configuration has been viewed 300 times in one hour, a second content item configuration has been viewed 450 times in one hour, and a third content item configuration has been viewed 500 times in one hour. In this example, when processing the online document configurations and the configuration attributes for online document 200, the selection factor determination module 135 can tag the first content item configuration with “high preference,” the second content item configuration with “medium preference,” and the third content item configuration with “low preference” in order with the number of times viewed per hour.

The data processing system 120 can obtain at least one bid value (ACT 420). For example, the data processing system 120 can obtain the at least one bid value for the content item from the database 140 or from the content provider 125 or content publisher 115, or any one or more components associated with either content provider 125 or content publisher 115, via the network 105. The bid value for the content item can be for the content item being displayed, viewed, or clicked. For example, the bid value for the content item can be $1 for being displayed, $5 for being viewed, and $10 for being clicked. The bid value for the content item can also be for which content item slot of the content item configuration the content item is allocated. Referring to the online document configuration 205 depicted in the example of FIG. 2, the bid value for the content item can be $10 for the content item slot 210 located at the banner ad position, $7 for the content item slot 210 located to the right of the first party content 215, and $5 for each of the content item slots 210 located to the left of the first party content 215. The bid value for the content item can also be based on the size of the content item slot to which the content item is allocated, or based on a designated number of content item slots to which the content item is allocated.

The data processing system 120 can obtain at least one click-through attribute (ACT 425). For example, the data processing system 120 can obtain a click-through attribute for each content item slot in the content item configuration from the database 140 or from the content provider 125 or content publisher 115, or any one or more components associated with either content provider 125 or content publisher 115, via the network 105. The click-through attribute for each content item slot can include a number of statistics for the content item slot, such as the click-through rate (CTR) or view-through rate (VTR). The CTR can be measured, for example, by the number of clicks on the content item slot versus the number of views of the content item slot. The VTR can be measured, for example, by the number of views of other content after clicking through the content item slot versus the number of views of the content item slot. The click-through attribute can be a weighted sum of the click-through rate and the view-through rate. The click-through attribute can be a dimensionless quantity ranging between 0 and 1. The click-through attribute can also be measured as a unit of time. The selection module 130 executing on the data processing system 120 or one or more components of system 100 can select the content item configuration (ACT 430). The selection module 130 can select the content item configuration based on at least one of the selection factor, the bid values for the content item, and the click-through attributes for the content item slot. For example, when processing the online document 200, the selection module 130 can select the content item configuration based on which configuration has the highest selection factor. In this example, suppose that online document configurations 205 and 305 have selection factors of 0.7 and 0.5 respectively. The selection module 130 can select online document configuration 205 for the online document 200, because the selection factor for online document configuration 205 is greater than that for the online document configuration 305.

The selection module 130 can select the content item configuration based on a combination of the selection factor, the bid values for each of the content items, and the click-through attributes for each of the content item slots. For example, when processing the online document 200, the selection module 130 can select the content item configuration based on which content item configuration has the highest value based on a function of the selection factor, the bid values for the content item, and the click-through attributes for the content item slot. Furthermore, suppose that online document configuration 205 has a selection factor of 0.7, a click-through attribute of 0.1 for the content item slot 210 along the top banner position of the online document 200, a click-through attribute of 0.09 for the content item slot 210 on the right margin of the online document 200, a click-through attribute of 0.08 for the top content item slot 210 on the left margin of the online document 200, and a click-through attribute of 0.07 for the bottom content item slot 210 on the left margin of the online document 200. Suppose further that online document configuration 305 has a selection factor of 0.5, a click-through attribute of 1.0 for the content item slot 210 that hovers over the first party content 215, a click-through attribute of 0.9 for the top content item slot 210 on the left margin of the online document 200, a click-through attribute of 0.8 for the middle content item slot 210 on the left margin of the online document 200, and a click-through attribute of 0.7 for the bottom content item slot 210 on the left margin of the online document 200. Also suppose that there are four content items that have bid values of $5, $4, $3, and $2 respectively. In this example, the selection module 130 can select online document configuration 305 over online document configuration 205, despite the fact that the selection factor for configuration 205 was greater than the selection factor for configuration 305 because of the higher click-through attributes for the content item slots in configuration 305.

The selection module 130 can select the content item configuration based on maximizing a combination of the selection factor, the bid value for the content item, and the click-through attribute for the content item slot. For example, the selection module 130 can select the content item configuration that maximizes a function in the form:

sₖΣⱼ₌₁^{k}x_{j,k}v₍ⱼ₎

where sₖ is the selection factor for content item configuration k, x_{j,k} is the click-through effect for content item slot j within the content item configuration k, and v₍ⱼ₎ is the bid value for content item slot j within the content item configuration k. The selection module 130 can select the content item configuration that maximizes the sum of the product of the click-through effect for the content item at a content item slot of the content item configuration and the bid value for the content item at the content item slot of the content item configuration, scaled by the selection factor.

The selection module 130 or any one or more components of system 100 can authorize a content item slot of the content item configuration to include the content item (ACT 435). The selection module 130 can allocate the content item with the j-th highest bid value for the content item into the j-th content item slot of the content item configuration. For example, suppose that one content item has a bid value of $10 and another content item has a bid value of $12. When processing the online document 200, the selection module 130 can authorize the first content item slot of the content item configuration to include the content item with the bid value of $12 and authorize the second content item slot of the content item configuration to include the content item with the bid value of $10.

The selection module 130 can also allocate the content item with the j-th highest bid value for the content item into the content item slot of the content item configuration with the j-th highest click-through attribute for the content item slot of the content item configuration, independent of the position for the content item slot within the content item configuration. For example, suppose that one content item slot has a click-through rate of 0.6 and another content item slot has a click-through rate 0.4 and one content item has a bid value of $13 and another content item has a bid value of $17. When processing the online document 200, the selection module 130 can authorize the first content item slot to include the second content item with the bid value of $17 and authorize the second content item slot to include the first content item with the bid value of $13.

The data processing system 120 can provide the online document 200 with the content item for display by a computing device 110 (ACT 440). The data processing system 120 or any one or more components of system 100 can provide the online document 200 with the content items for display in the selected content item configuration (e.g., online document configuration 205 or 305). For example, when the computing device 110 transmits a request for online document 200, the data processing system 120 or any one or more components of system 100 can provide the online document 200 with one of the online document configurations 205 or 305 selected and the content items for display by the computing device 110 via the network 105.

The data processing system 120 or one or more components of system 100 can provide the online document 200 with one of the online document configurations 205 or 305 selected with the content item slots 210 authorized to include content items. For example, when the computing device 110 transmits a request for online document 120, the data processing system 120 or any one or more components of system 100 can provide the online document 200 with one of the online document configurations 205 or 305 selected and authorizations for the content item slots 210 to include the content items via the network 105 to the computing device 110. In this example, the content provider 125 or the content publisher 115 can provide the content items via the network 105 to the computing device.

The data processing system 120 or any one or more components of system 100 can provide the content item configuration (e.g. online document configurations 205 or 305) authorized to include the content item. For example, when the computing device 110 transmits a request for online document 200, the data processing system 120 can provide the selected online document configuration 205 or 305 with authorizations for the content item slots 210 to include content items via the network 105. In this example, the content publisher 115 can provide the online document 200 with the first party content 215 and the content provider 125 can provide the content items via the network 105.

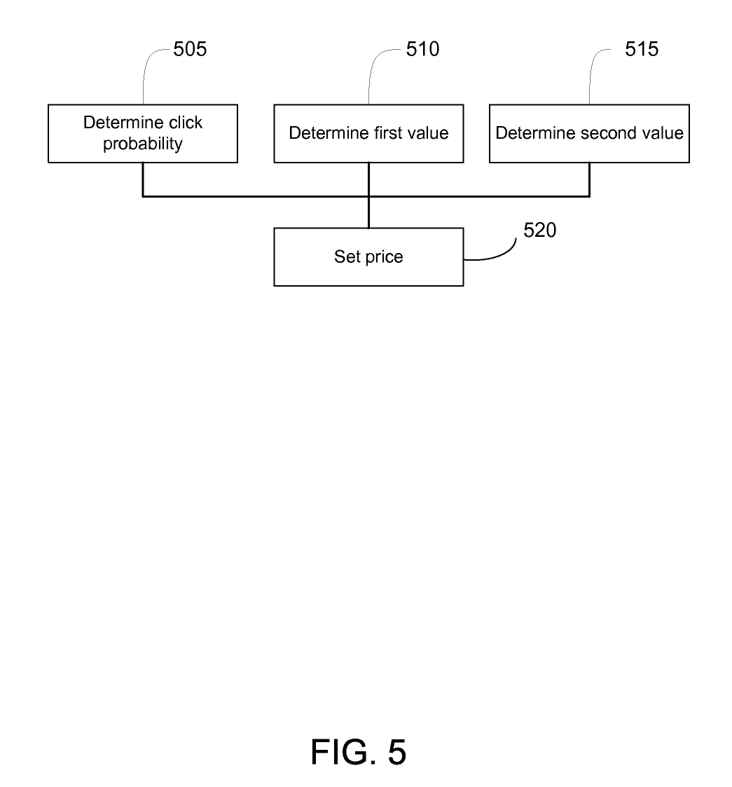

FIG. 5 is an illustration of a method or workflow 500 for optimizing the configuration of content items for display with an online document. The method 500 can be performed or be executed by one or more components of system 100 shown in FIG. 1. including, e.g., the data processing system 120. The method 500 can be performed or executed at various time intervals, ranging from once every few seconds or minutes to once every predetermined number of days. The method 500 can be performed or executed upon the fulfillment of a conditional, such as reaching a predetermined number of visitors on the online document or website. The method 500 can also be performed or executed every time a user visits the online document 200 or website. Each act of method 500 can be executed prior to, in conjunction with, or after each act of method 400.

The data processing system 120 can determine a click probability (ACT 505). A click probability determination module executing on the data processing system 120 or any one or more components of the system 100 can determine a click probability. The data processing system 120 can determine the click probability for a content item slot based on the traffic statistics of content item configurations with similar characteristics. For example, suppose that the click probabilities for the content item slots 210 of online document configuration 205 are known, and the click probability for the top banner content item slot 210 is 0.5, the left top content item slot 210 is 0.3, the left bottom content item slot is 0.25, and the right margin content item slot is 0.35. The click probabilities for the content item slots 210 of the online document configuration 305 have not previously been recorded or measured. In this example, when calculating the click probabilities for online document configuration 305, the data processing system 120 can estimate the click probabilities of content item slots 210 for online document configuration 305 by the similarity of positions within the online document. The data processing system 120 can determine the click probability for the top left content item slot is 0.28, the middle left content item slot is 0.26, and the bottom left content item slot is 0.18. The data processing system 120 can determine the click probability for the embedded content item slot 120 using other online document configurations besides online document configuration 205. The click probabilities are examples, as these values can vary. Furthermore, similar characteristics can include other characteristics besides similarity of position, such as relation of first party content 215 to content item, similarity of the topic category of the content items, and similarity of content item providers 125.

The data processing system 120 can determine a first value (ACT 510). A value determination module executing on the data processing system 120 can determine the first value. The data processing system 120 can determine the first value for a content item slot of a content item configuration, by determining the configuration that would have been selected if the content item in the content item slot had not been available. For example, if the top banner content item slot 210 in online document 200 displays content item x, the data processing system 120 can determine the first value for content item x by determining the configuration that would have been selected if content item x had not been available.

The data processing system 120 can determine the first value for a content item slot of the content item configuration by determining the configuration that would have been selected if the content item in the content item slot had not been available, based on the selection factor for the alternative content item configuration, the bids of the content items in the alternative content item configuration, and the click-through attributes of the content item slots in the alternative content item configuration. For example, when determining the first value, the value determination module or the data processing system 120 can retrieve the selection factor for the alternative content item configuration, the bids of the content items in the alternative content item configuration, and the click-through attributes of the content item slots in the alternative content item configuration from the database 140 or any one or more components of system 100. The value determination module or data processing system 120 can then determine the first value based on the form: S_{j,K}=maxₖsₖ(Σᵢ₌₁^{j-1}x_{i,k}v₍ᵢ₎+Σᵢ₌ⱼ^{k}x_{i,k}v₍ᵢ₊₁₎)

where S_{j,K} is the first value for the j-th content item slot in a content item configuration with the number of content item slots ranging from 1 to K, sₖ is the selection factor for the configuration with k content item slots, x_{i,k} is the click-through effect for content item slot i within the content item configuration with k content item slots, and v₍ᵢ₎ is the i-th highest bid value.

The data processing system 120 can determine a second value (ACT 515). The value determination module executing on the data processing system 120 can determine a second value. The data processing system 120 can determine the second value for a content item slot of a content item configuration, in which the content item has not been authorized to include the content. For example, if the top banner content item slot 210 in online document 200 has been authorized to include content item x, the data processing system 120 can determine the second value for content item x by summing the bid values of the content items authorized weighted by the click probabilities for the other three content item slots. In this example, if the click probabilities were 0.2 for the top left content item slot 210, 0.15 for the bottom left content item slot 210, and 0.25 for the right margin content item slot 210 and the bid values were $12 for the top left content item slot, $11 for the bottom left content item slot, and $15 for the right margin content item slot, then the data processing system 120 can determine the second value to be 7.8. The data processing system 120 can further scale the second value by the selection factor. In this example, if the selection factor for the content item configuration is 0.7, the data processing system 120 can scale the second value by the selection factor and determine that the scaled second value is 5.46. These numbers are used as examples, as bid values, the click probabilities, and selection factor can vary.

The data processing system 120 can determine the second value based on a measure of the effect on other content item slots of a content item configuration besides the content item slot authorized to include the content item, based on the selection factor for the content item configuration, the bids of the other content items in the content item configuration, and the click-through attributes of the other content item slots in the content item configuration. For example, when determining the second value, the value determination module or the data processing system 120 can retrieve the selection factor for the content item configuration, the bids of the other content items in the content item configuration, and the click-through attributes of the other content item slots in the content item configuration from the database 140 or any one or more components of system 100. The value determination module or the data processing system 120 then can determine the second value based on the form:

R_{j,k}=sₖΣ_{i≠j}x_{i,k}v₍ᵢ₎

where R_{j,k} is the second value for the j-th content item slot in a content item configurations with k content item slots, sₖ is the selection factor for the configuration with k content item slots, x_{i,k} is the click-through effect for content item slot i within the content item configuration with k content item slots, and v₍ᵢ₎ is i-th highest bid value.

The data processing system 120 can set the price (ACT 520). A price determination module executing on the data processing system 120 can determine the price. The data processing system 120 can set the price based on the difference between the first value and the second value. For example, if the scaled first value is 10 and the scaled second value is 5.46, the data processing system 120 can determine the price to be $4.54. The data processing system 120 can further inversely scale the difference by the click probability and the selection factor. In this example, if the click probability is 0.8 and the selection factor is 0.7, the data processing system can determine the scaled difference to be $8.11.

The data processing system 120 can set the price based on the difference between the first value and the second value, scaled by the click probability, the selection factor, and the click-through attribute for the content item slot of the content item configuration. For example, the price set by the price determination module or the data processing system 120 can be in the form:

$${p}_{j} = \frac{1}{{s}_{k} {q}_{( j )} {x}_{j , k}} ( {S}_{j , K} - {R}_{j , k} )$$

where pⱼ is the price set for the j-th content item slot in the content item configuration, q₍ⱼ₎ is the click-through probability for the content item in the j-th content item slot, x_{j,k} is the click-through effect for the j-th content item slot in a content item configuration with k slots, S_{j,K} is the first value for the j-th content item slot for content item configurations with 1 to K content item slots, and R_{j,k} is the second value for the j-th content item slot for a content item configuration with k content item slots.

The data processing system 120 can also limit the price up to the bid value of the content item. For example, if the data processing system 120 using the selection factor has determined that the price for the content item slot of the content item configuration is $17 and the bid value for the content item slot is $15, the data processing system 120 can set the price to $15 for the content item slot.

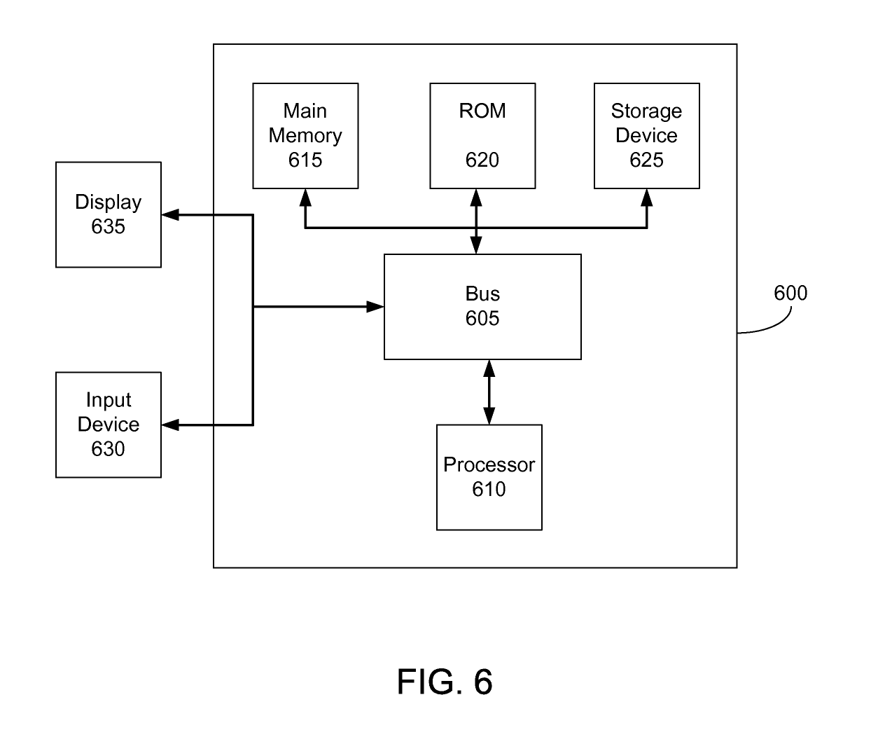

FIG. 6 is a block diagram of a computer system 600 in accordance with an illustrative implementation. The computer system or computing device 600 can include, be part of, or be used to implement the system 100, content provider 125, computing device 110, content publisher 115, and data processing system 120. The computing system 600 includes a bus 605 or other communication component for communicating information and a processor 610 or processing circuit coupled to the bus 605 for processing information. The computing system 600 can also include one or more processors 610 or processing circuits coupled to the bus for processing information. The computing system 600 also includes main memory 615, such as a random access memory (RAM) or other dynamic storage device, coupled to the bus 605 for storing information, and instructions to be executed by the processor 610. Main memory 615 can also be used for storing position information, temporary variables, or other intermediate information during execution of instructions by the processor 610. The computing system 600 may further include a read only memory (ROM) 620 or other static storage device coupled to the bus 605 for storing static information and instructions for the processor 610. A storage device 625, such as a solid state device, magnetic disk or optical disk, is coupled to the bus 605 for persistently storing information and instructions.

The computing system 600 may be coupled via the bus 605 to a display 635, such as a liquid crystal display, or active matrix display, for displaying information to a user. An input device 630, such as a keyboard including alphanumeric and other keys, may be coupled to the bus 605 for communicating information and command selections to the processor 610. The input device 630 can include a touch screen display 635. The input device 630 can also include a cursor control, such as a mouse, a trackball, or cursor direction keys, for communicating direction information and command selections to the processor 610 and for controlling cursor movement on the display 635.

The processes, systems and methods described herein can be implemented by the computing system 600 in response to the processor 610 executing an arrangement of instructions contained in main memory 615 or read only memory ROM 620. Such instructions can be read into main memory 615 from another computer-readable medium, such as the storage device 625. Execution of the arrangement of instructions contained in main memory 615 causes the computing system 600 to perform the illustrative processes described herein. One or more processors in a multi-processing arrangement may also be employed to execute the instructions contained in main memory 615. In alternative implementations, hard-wired circuitry may be used in place of or in combination with software instructions to effect illustrative implementations. Thus, implementations are not limited to any specific combination of hardware circuitry and software.

Although an example computing system has been described in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Implementations of the subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices).

The operations described in this specification can be performed by a data processing apparatus on data stored on one or more computer-readable storage devices or received from other sources.

The term “data processing apparatus” or “computing device” encompasses various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a standalone program or as a circuit, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more circuits, sub programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular implementations of the subject matter have been described. Other implementations are within the scope of the following claims. While operations are depicted in the drawings in a particular order, this should not be understood as requiring that such operations be performed in the particular order shown or in sequential order, or that all illustrated operations are required to be performed. Actions described herein can be performed in a different order. In addition, the processes depicted in the accompanying figures do not necessarily require the particular order shown, or sequential order, to achieve desirable results. In certain implementations, multitasking and parallel processing may be advantageous.

The separation of various system components does not require separation in all implementations, and the described program components can be included in a single hardware or software product. For example, the selection module 130 or the selection factor determination module 135 can be a single module, a logic device having one or more processing circuits, or part of an online content item placement system.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementation,” “an alternate implementation,” “various implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A method of optimizing a configuration of content items for display with an online document, comprising:
identifying, from at least one content database, by the data processing system, a content item configuration for the online document and a configuration attribute for the content item configuration, the content item configuration comprising a content item slot;
determining, by a selection factor determination module executing on the data processing system, a selection factor for the content item configuration based on the configuration attribute;
obtaining, by the data processing system, a bid value for a content item and a click-through attribute for the content item slot of the content item configuration;
selecting, by a selection module executing on the data processing system, the content item configuration based on the selection factor, the bid value for the content item, and the click-through attribute for the content item slot of the content item configuration;
authorizing, by the selection module, the content item slot of the content item configuration to include the content item; and
providing, by the data processing system, the online document with the content item for display by a computing device.

2. The method of claim 1, comprising:
identifying, from the at least one content database, the configuration of the online document, the configuration comprising a plurality of content item slots;
authorizing, by the selection module, a plurality of content items corresponding to the plurality of content item slots.

3. The method of claim 1, comprising:
identifying, from the at least one content database, the configuration attribute for the content item configuration, the configuration attribute comprising a number of times that the content item configuration was displayed on the online document.

4. The method of claim 1, comprising:
identifying, from the at least one content database, the configuration attribute for the content item configuration, the configuration attribute comprising a number of times that the content item configuration was displayed on a plurality of online documents.

5. The method of claim 1, comprising:
determining, by the selection factor determination module, the selection factor for the content item configuration based on a non-increasing function of the configuration attribute.

6. The method of claim 1, comprising:
selecting, by the selection module, the content item configuration based on maximizing a combination of the selection factor, the bid value for the content item, and the click-through attribute for the content item slot.

7. The method of claim 1, comprising:
determining, by a probability determination module executing on the data processing system, a click probability for the content item slot.

8. The method of claim 7, comprising:
determining, by a value determination module executing on the data processing system, a first value for a content item slot of a first content item configuration, the first value based on the first content item configuration selected when the content item is unavailable;
determining, by the value determination module, a second value for a first content item slot of a second content item configuration, the first content item slot authorized to include the content item and the second value based on a click-through effect on a second content item slot of the second item configuration; and
setting, by a price determination module executing on the data processing system, a price for the content item based on the click probability, the first value, and the second value.

9. The method of claim 8, comprising:
setting, by the price determination module, the price for the content item based on a difference of the first value and the second value, scaled by the click probability and the selection factor.

10. The method of claim 8, comprising:
setting, by the price determination module, the price for the content item, the price being less than or equal to the bid value for the content item.

11. A system for optimizing a configuration of content items for display with an online document comprising:
a data processing system having at least one processor configured to identify from at least one content database a content item configuration for the online document and a configuration attribute for the content item configuration, the content item configuration comprising a content item slot;
a selection factor determination module executing on the data processing system configured to determine a selection factor for the content item configuration based on the configuration attribute;
the data processing system configured to obtain a bid value for a content item and a click-through attribute for the content item slot of the content item configuration;
a selection module executing on the data processing system configured to select the content item configuration based on the selection factor, the bid value for the content item, and the click-through attribute for the content item;
the selection module configured to authorize the content item slot of the content item configuration to include the content item; and
the data processing system configured to provide the online document with the content item for display by a computing device.

12. The system of claim 11, comprising:
the data processing system configured to identify from the at least one content database the configuration of the online document, the configuration comprising a plurality of content item slots; and
the selection module configured to authorize a plurality of content items corresponding to the plurality of content item slots.

13. The system of claim 11, comprising:
the data processing system configured to identify from the at least one content database the configuration attribute for the content item configuration, the configuration attribute comprising a number of times that the content item configuration was displayed on a plurality of online documents.

14. The system of claim 11, comprising:
the selection factor determination module configured to determine the selection factor for the content item configuration based on a non-increasing function of the configuration attribute.

15. The system of claim 11, comprising:
the data processing system configured to select the content item configuration based on maximizing a combination of the selection factor, the bid value for the content item, and the click-through attribute for the content item.

16. The system of claim 11, comprising:
a probability determination module executing on the data processing system configured to determine a click probability for the content item slot.

17. The system of claim 16, comprising:
a value determination module executing on the data processing system configured to determine a first value for a content item slot of a first content item configuration, the first value based on the first content item configuration selected when the content item is unavailable, and a second value for the first content item slot of a second content item configuration, the first content item slot authorized to include the content item and the second value based on a click-through effect on a second content item slot of the second content item configuration; and
a price determination module executing on the data processing system configured to set a price for the content item based on the click probability, the first value, and the second value.

18. The system of claim 17, wherein the price is based on a difference of the first value and the second value, scaled by the click-through probability and the selection factor.

19. A computer readable storage medium storing instructions that when executed by one or more data processors, cause the one or more data processors to perform operations comprising:
identifying, from at least one content database a content item configuration for an online document and a configuration attribute for the content item configuration, the content item configuration comprising a content item slot;
determining a selection factor for the content item configuration based on the configuration attribute;
obtaining a bid value for a content item and a click-through attribute for the content item slot;
selecting the content item configuration based on the selection factor, the bid value for the content item, and the click-through attribute for the content item slot of the content item configuration;
authorizing the content item slot of the content item configuration to include the content item; and
providing the online document with the content item for display by a computing device.

20. The computer readable storage medium of claim 19, storing instructions that when executed by one or more data processors, cause the one or more data processors to perform operations comprising:
determining a click probability for the content item slot;
determining a first value for a content item slot of a first content item configuration, the first value based on the first content item configuration selected when the content item is unavailable;
determining a second value for a first content item slot of a second content item configuration, the first content item slot authorized to include the content item and the second value based on a click-through effect on a second content item slot of the second item configuration; and
setting a price for the content item based on the click probability, the first value, and the second value.
